(19) United States
(12) Patent Application Publication
(10) Pub. No.: US 2012/0250578 A1
(43) Pub. Date: Oct. 4, 2012

(54) MULTI-CELL OPERATION IN NON-CELL_DCH STATES

(75) Inventors: Diana Pani, Montreal (CA); Christopher Cave, Dollard-des-Ormeaux (CA); Paul Marinier, Brossard (CA)

(73) Assignee: INTERDIGITAL PATENT HOLDINGS, INC., Wilmington, DE (US)

(21) Appl. No.: 13/435,851

(22) Filed: Mar. 30, 2012

Related U.S. Application Data
(60) Provisional application No. 61/470,903, filed on Apr. 1, 2011.

(51) Int. Cl. H04W 36/08; H04W 24/00; H04W 72/04

(52) U.S. Cl. 370/254; 370/331

(57) ABSTRACT

A method and wireless transmit/receive unit (WTRU) for establishing multi-cell operation in a non-fully connected state are disclosed. The method may include the WTRU accessing a primary cell. The method may include the WTRU determining at least one potential secondary cell. The method may include the WTRU initiating access to the at least one potential secondary cell while simultaneously accessing the primary cell in a non-fully connected state. The non-fully connected state may correspond to the WTRU accessing the primary cell without dedicated radio resources being allocated to the WTRU.

### CROSS REFERENCE TO RELATED APPLICATIONS

This application claims the benefit of U.S. Provisional Patent Application No. 61/470,903 filed Apr. 1, 2011, the contents of which is hereby incorporated by reference herein.

### TECHNICAL FIELD

This application is related to wireless communication systems.

### BACKGROUND

Mobile networks have experienced continuous increases in data traffic due to the introduction of new mobile services and applications. Such traffic is often characterized by a high level of burstiness (e.g. transmissions are intermittent and/or transmitted in short, uneven spurts) and small packet sizes. In Universal Mobile Telecommunications System (UMTS) networks, wireless transmit/receive units (WTRUs) may experience varying traffic demands. During periods of low activity a WTRU may operate in non-fully connected states, such as CELL_FACH or CELL_PCH. The CELL_FACH and CELL_PCH states have been improved in previous releases to allow the utilization of enhanced data channels in the downlink and uplink, for example transmission over the High Speed Downlink Shared Channel (HS-DSCH) and/or the Enhanced Dedicated Channel (E-DCH). The enhanced data channels allow for fast transfer of signaling messages which may reduce the latency for transition to a fully connected state (e.g., CELL_DCH). The enhanced data channels also may allow for transfer of some data packets while the WTRU remains in one of the non-fully connected states.

These improvements, introduced in 3GPP Releases 7 and 8, provide a user experience that is closer to “always-on connectivity” while maintaining low battery consumption. A number of other improvements have been introduced in 3GPP Release 7 and beyond for fully connected WTRUs (e.g., WTRUs operating in CELL_DCH state). However, it may be desirable to further design systems that improve WTRU performance in non-connected states.

### SUMMARY

A method and device (e.g., a wireless transmit/receive unit (WTRU)) for establishing multi-cell operation in a non-fully connected state are disclosed. The method may include the WTRU accessing a primary cell. The method may include the WTRU determining at least one potential secondary cell. The method may include the WTRU initiating access to the at least one potential secondary cell while simultaneously accessing the primary cell in a non-fully connected state. The non-fully connected state may correspond to the WTRU accessing the primary cell without dedicated radio resources being allocated to the WTRU.

The WTRU may determine the at least one potential secondary cell based on a list potential secondary cells broadcast by the primary cell. The list of potential secondary cells may be included in an information element of a system information block (SIB) of the primary cell. The WTRU may determine which cells included on the list of potential secondary cells that it is allowed to access based on WTRU specific access restriction information received from a Node B. The WTRU may receive an indication from the primary cell. The indication may indicate whether the primary cell supports multi-cell reception for WTRUs in the non-fully connected state.

The WTRU may receive configuration information for the at least one potential secondary cell from the primary cell. The configuration information may include at least one of an indication of a scrambling code used by the at least one potential secondary cell or common pilot indicator channel (CPICH) information for the at least one potential secondary cell. The non-fully connected state may be a CELL_FACH state.

A wireless transmit/receive unit (WTRU) comprising a processor coupled to a transceiver. The processor may be configured to access a primary cell, determine configuration information for at least one potential secondary cell, and activate the at least one potential secondary cell while simultaneously accessing the primary cell in a non-fully connected state. The WTRU may activate the at least one potential secondary cell in response to a transition to a CELL_FACH state. The WTRU may activate the at least one potential secondary cell in response to receiving downlink transmissions from the primary cell. The WTRU may activate the at least one potential secondary cell based on the WTRU operating in a CELL_FACH state and High Speed-Data Shared Channel (HS-DSCH) reception being configured in the primary cell.

The WTRU may delete the configuration information for the at least on potential secondary cell based on the WTRU performing a cell reselection, the WTRU transitioning from a CELL_FACH state, or the WTRU detecting radio link failure (RLF). The WFRU may activate the at least one potential secondary cell in response to downlink transmissions over a predetermined time period exceeding a predetermined threshold. The WTRU may activate the at least one potential secondary cell in response to a dedicated message from a Node B serving the primary cell. The dedicated message may be one of a physical layer message, a medium access control (MAC) control element (CE) or a radio resource control (RRC) message. The WTRU may send feedback regarding the at least one potential secondary cell to the primary cell. The WTRU may send High Speed-Downlink Control Channel (HS-DCCH) uplink feedback after the processor activates the at least one potential secondary cell.

A Node B may include a processor and a transceiver configured to establish multi-cell operation in a non-fully connected state. The Node B may provide access to a core network for a wireless transmit/receive unit (WTRU) via at least two cells. The at least two cells may include a primary cell and a secondary cell. The Node B may determine configuration information for the secondary cell. The configuration information may be configured to allow the WTRU to access the secondary cell while in a non-fully connected state. The non-fully connected state corresponds to the WTRU accessing the primary cell without dedicated radio resources being allocated to the WTRU. The Node B may broadcast the configuration information for the secondary cell over the primary cell. The Node B may send a message to the WTRU, and the message may request that the WTRU begin reception of the secondary cell. The Node B may receive a measurement report for the secondary cell from the WTRU via the primary cell.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A; and

FIG. 2 is a flow chart illustrating an example method for configuring a secondary cell.

### DETAILED DESCRIPTION OF ILLUSTRATIVE EMBODIMENTS

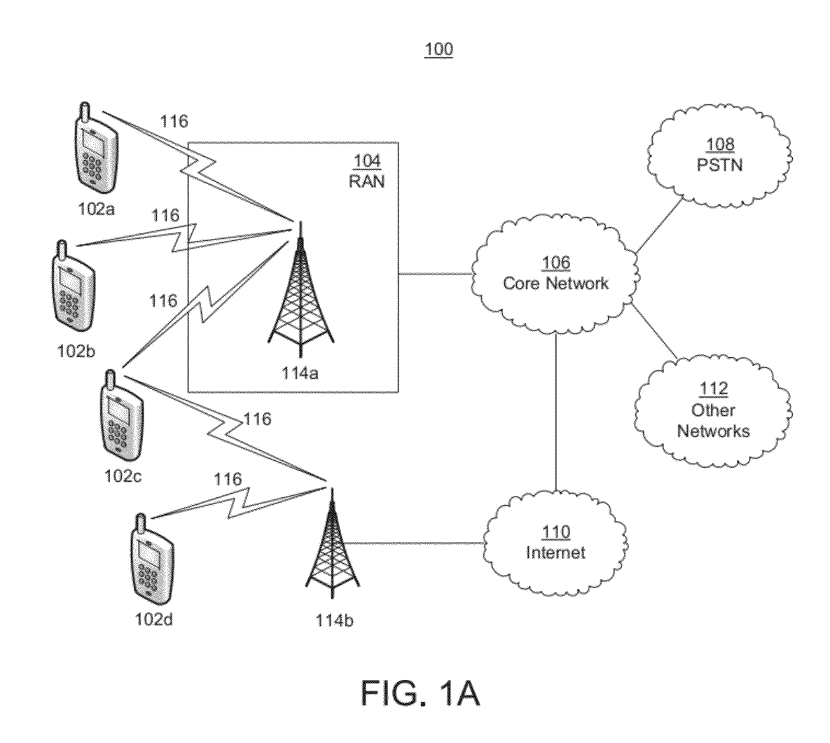

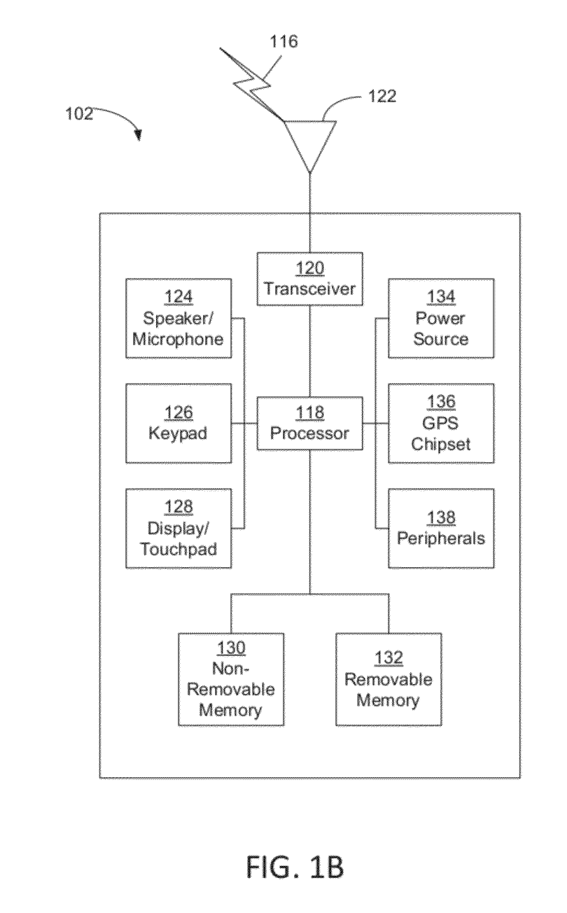

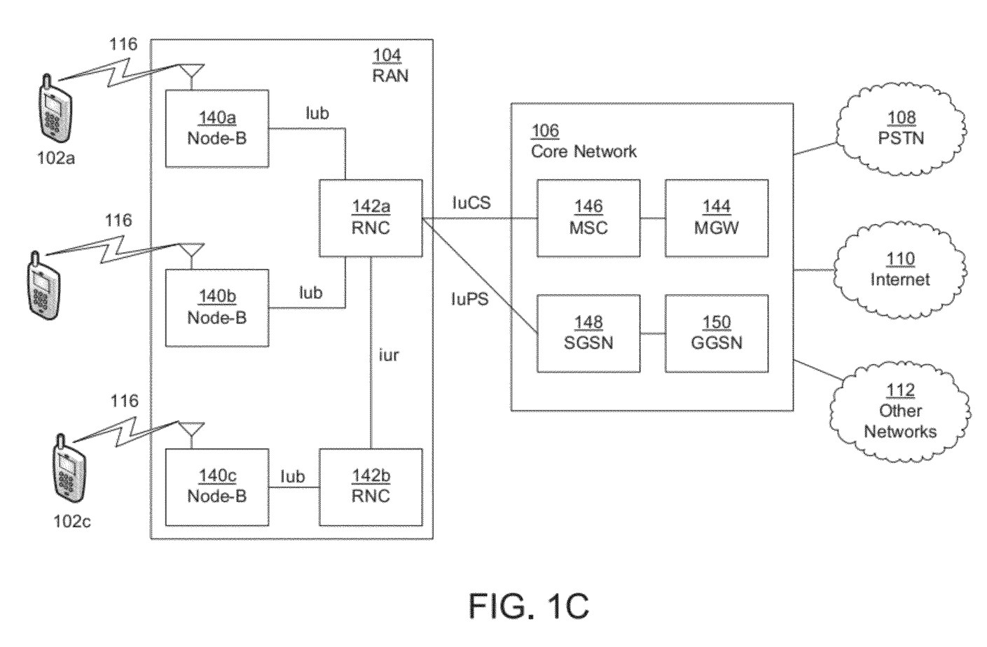

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or high-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 IX, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136 the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102h, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RACs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140h, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 342a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 1021, 102c and IP-enabled devices.

As noted above, the core network 106 may also be connected to the networks 112, which may include other wired or wireless networks that are owned and/or operated by other service providers.

In order to improve reception and increase data rates while maintaining relatively low battery consumption, enhancements may be made to WTRU procedures in non-fully connected states. A WTRU connection state may refer to a state in which the WTRU is configured to perform procedures that are associated with that state. A WTRU connection state may be characterized by the type and/or number of radio resources allocated to the WTRU for transmission and/or reception. For example, a WTRU connection state may be characterized by, whether or not dedicated radio resources are allocated to the WTRU. A WTRU connection state may refer to a radio resource control (RRC) state of the WTRU. If a WTRU is connected to more than one cell, the connection state of the WTRU may be associated with configuration information of a primary cell for that WTRU.

A “fully connected state” may be characterized by dedicated radio resources of a dedicated physical channel being allocated to the WTRU in the uplink, the downlink, or the uplink and downlink. In UMTS, an example of a “fully connected” WTRU connection state may include, but is not limited to, the CELL_DCH state. For example, WTRUs in the CELL_DCH state may be allocated dedicated channels in the uplink and in the downlink. In an example, while in the CELL_DCH state a dedicated physical channel may be allocated to the WTRU in the uplink and the HS_DSCH_RECEPTION variable may be set to TRUE (e.g., in time division duplex (TDD) mode). While in the CELL_DCH state, dedicated transport channels, downlink and uplink shared transport channels, and/or a combination of dedicated and shared transport channels may be used by the WTRU. For example, a physical downlink shared channel (PDSCH) may be assigned to the WTRU in the CELL_DCH state, which may be used for reception of a downlink shared channel (DSCH) transport channel. A physical uplink shared channel (PUSCH) may be assigned to a WTRU in the CELL_DCH state, which may be used for uplink transmissions for an uplink shared channel (USCH) transport channel, PDSCH or PUSCH are used (e.g., for TDD operation), a forward access channel (FACH) transport channel may be assigned to the WTRU for reception of physical shared channel allocation messages. A WTRU may enter the CELL_DCH state from the Idle Mode through the setup of an RRC connection. A WTRU may enter the CELL_DCH state from the CELL_FACH state by establishing a dedicated physical channel, for example a downlink dedicated physical channel.

The terms “non-fully connected state” and “non-DCH state” may be used interchangeably. A “non-fully connected state” or a “non-DCH state” may describe a WTRU connection state characterized by the WTRU being less than fully connected to a particular RAN. For example, when in a non-DCH state, the set of resources utilized by the WTRU for DL reception and/or UL transmission may be common or non-dedicated. A common or non-dedicated radio resource may be a resource that may be shared among a plurality of WTRUs and/or may be contended for by a plurality of WTRUs. A common or non-dedicated channel may be a channel that may be shared and/or multiplexed among a plurality of WTRUs and/or may be contended for by a plurality of WTRUs. There may be common resources for dedicated channels. Dedicated radio resources may be resources associated with a dedicated channel that are assigned to a particular WTRU for an indefinite period of time. For example, a WTRU may be assigned dedicated radio resources by a Node-B, and the assigned dedicated radio resources may be utilized by the WTRU in a contention free manner until the dedicated radio resources are released by the network. In one example, a non-fully connected state or non-DCH state may refer to a state in which there are no dedicated control channels allocated to the WTRU. In an example, a non-fully connected state or a non-DCH state may be defined based on the type of downlink connection maintained by the WTRU. For example, a non-fully connected state or a non-fully connected state may refer to a state where no dedicated downlink channels are allocated to the WTRU, For example, a non-fully connected state or non-DCH state may be characterized by the absence of dedicated channels being allocated to the WTRU in both the uplink and downlink.

For UMTS, the terms non-fully connected state and non-DCH state may include, but are not limited to, IDLE mode, URA_PCH state, CELL_DCH state, and/or CELL_FACH state. A non-fully connected state or a non-DCH state may be characterized by, functionality that differs from the functionality of a fully connected and/or CELL_DCH state. For example, a CELL_DCH state may be characterized by dedicated radio resources of one or more dedicated channels being allocated to a WTRU. A non-fully connected state or a non-DCH state may be characterized by no dedicated radio resources being allocated to the WTRU, for example if no dedicated channels are allocated to the WTRU. A non-fully connected state or a non-DCH state may be characterized by no dedicated radio resources being allocated to the WTRU, although common resources of a dedicated channel may still be allocated to the WTRU in the non-fully connected state. In an example, a non-fully connected state or non-DCH state may be characterized by no dedicated control channels being allocated to the WTRU (e.g., no dedicated downlink control channels).

In an example, a WTRU in a non-fully connected or non-DCH state may utilize common resources of dedicated channels. For example, common enhanced uplink dedicated channel (E-DCH) resources may be used by a WTRU for uplink transmissions in a non-fully connected state. The common E-DCH resources to be used may be broadcast throughout the cell via a broadcast channel (BCH). In order to utilize E-DCH resources in a non-fully connected state, a WTRU may perform a contention resolution procedure with base station (e.g., Node-B), as one or more other WTRUs may also attempt to utilize the same common E-DCH resources. Thus, a WTRU may send data via the E-DCH using common resources in a non-fully connected or non-DCH state. For the purposes of this disclosure, utilization of common or shared resources of dedicated channels may be considered distinct from an allocation of dedicated radio resources of dedicated channels. The use (or allocation) of dedicated radio resources of dedicated channels may be associated with a fully connected state. The use (or allocation) of common resources of dedicated channels may be associated with a non-fully connected or non-DCH state (although the fully connected states may also make use of common resources in addition to dedicated radio resources).

Example non-DCH states may include the CELL_FACH state, the CELL_PCH state, the URA_PCH state and/or IDLE mode. In one example, non-DCH states may each include connection state that is different from CELL_DCH. In an example, non-DCH state may refer to CELL_FACH. The CELL_FACH state may be characterized by no dedicated physical channel being allocated to the WTRU and/or the WTRU continuously monitoring a FACH in the downlink. In an example, the CELL_FACH state may be characterized by no dedicated physical channel being allocated to the WTRU and/or the WTRU continuously monitoring a HS-DSCH in the downlink (and optionally a FACH for multimedia broadcast multicast service (MBMS) reception). The WTRU in the CELL_FACH state may be assigned a default common or shared transport channel in the uplink a random access channel (RACH) and/or common E-DCH resources) that may be used according to the access procedure for that transport channel. The position of a WTRU in a CELL_FACH state may be known by the UTRAN on cell level according to the cell where the WTRU last performed a cell update. In an example, one or several USCH or DSCH transport channels may have been established for WTRUs in a CELL_FACH state.

Example non-DCH states may include the CELL_PCH state. The CELL_PCH state may be characterized by no resources having been granted for uplink data transmission. For example, no uplink activity may be possible in the CELL_PCH state. To transmit data in the uplink, a transition to another state may be executed by the WTRU. In an example, if “HS-DSCH paging system information” is not included in System Information and/or the WTRU does not support HS-DSCH reception in CELL_PCH state, the CELL_PCH state may be characterized by no dedicated physical channels being allocated to the WTRU. A WTRU in the CELL_PCH state may select a paging channel (PCH) to monitor using discontinuous reception (DRX) via an associated paging indicator channel (PCH). In an example, if “HS-DSCH paging system information” is included in System Information and the WTRU supports HS-DSCH reception in the CELL_PCH and URA_PCH states, common resources of a dedicated physical channel may be allocated to a WTRU in the CELL_PCH state and/or a WTRU in the CELL_PCH state may select an HS-DSCH mapped on the high speed physical downlink shared channel (HS-PDSCH) and use DRX to monitor the selected HS-DSCH via an associated PICH. The position of a WTRU in the CELL_PCH state may be known by the UTRAN on cell level according to the cell where the WTRU last performed a cell update in CELL_FACH state. In CELL_PCH state the WTRU may receive dedicated control channel (DCCH) and/or of a dedicated traffic channel (DTCH) logical channels, for example if HS-DSCH is used and a dedicated HS-DSCH radio network temporary identifier (H-RNTI) is configured and/or a dedicated E-DCH RNTI (E-RNTI) is configured. If the network wants to initiate any other activity, it may make a paging request on the PCCH logical channel in cell last used to initiate any downlink activity to the WTRU.

Example non-DCH states my include the URA_PCH state. The URA_PCH may be characterized by no dedicated physical channels being allocated to the WTRU. WTRUS in the URA_PCH state may be characterized by a lack of uplink activity. In an example, if “HS-DSCH paging system information” is not included in System Information and/or the WTRU does not support HS-DSCH reception in the CELL_PCH and/or URA_PCH states, a WTRU in the URA_PCH state may select a PCH to monitor using DRX via an associated RICH. If “HS-DSCH paging system information” is included in System Information and the WTRU supports HS-DSCH reception in the CELL_PCH and/or URA_PCH states, the WTRU may select an HS-DSCH mapped on the HS-PDSCH and use DRX to monitor the selected HS-DSCH via an associated PICH. Typically, the DCCH logical channel may not be used in the URA_PCH state. If the network wants to initiate any activity, it may make a paging request on the PCCH logical channel within the UTRAN registration area (URA) last reported by the WTRU. If the WTRU determines it should transmit data to the network, the WTRU may transition to the CELL_FACH state. The transition to the URA_PCH state may be controlled with an inactivity timer and/or using a counter that counts the number of cell updates. When the number of cell updates has exceeded a predetermined limit (e.g., a limit signaled by the network), the WTRU may transition to the URA_PCH state. URA updating may be initiated by the WTRU, for example upon the detection in a change in its current registration area. The WTRU may send the network the registration area update information on the RACH of the new cell. Any activity may cause the WTRU to transition out of the URA_PCH state (e.g., to the CELL_FACH state).

Methods to enable multi-cell operation in non-DCH states are described herein. For example, a WTRU may utilize the HS-DSCH for downlink reception in CELL_FACH, CELL_PCH, and/or URA_PCH states. Use of the HS-DSCH may allow for higher data rates, lower latency transfers for WTRUs, and/or load balancing opportunities in the network outside of the CELL_DCH state. In order to increase peak downlink data rates, simultaneous reception on two or more downlink carriers may be implemented for WTRUs outside of the CELL_PCH state. When used herein simultaneous reception over two or more cells may refer to a WTRU that is engaging in concurrent downlink reception from two or more downlink carriers. The WTRU my be configured by the RNC to support multi-cell reception. The RNC may identify the cells to which the WTRU will connect. The RNC may provide the WTRU with parameters for operation over more than one cell.

Multi-cell operation may refer to a configuration wherein the WTRU may receive data from two or more cells. For example, the two or more cells may be located in different frequencies or the same frequency in the same Node B or same geographical area. In another example, the two or more cells may be different Node Bs using the same or different frequencies. In an example, the two or more cells may be in different sectors for the same or different Node Bs. In multi-cell operation the WTRU may be configured with a primary cell and one or more secondary cells.

For example, such functionality may be implemented using Dual-Cell High Speed Downlink Packet Access (DC-HSDPA) for WTRUs in the CELL_FACH state. A WTRU in a non-DCH state may receive data simultaneously from two or more cells. Such reception may also be referred to as simultaneous reception on multiple frequencies or simultaneous reception on multiple frequency bands. By allowing a WTRU to receive data from multiple cells at substantially the same time, the network (e.g., the RNC) may perform dynamic load balancing of traffic across multiple HS-DSCH frequencies to WTRUs outside of the CELL_PCH state.

In order to facilitate the application of multi-cell operation of WTRUs in non-DCH states, a number of design details may be specified. For example, a WTRU may be designed to acquire configuration information or otherwise be configured to operate in a non-DCH state with multi-cell operation. A WTRU may determine when simultaneous reception across multiple cells (e.g., across multiple frequency bands) in a non-DCH state is supported. For example, the network and/or the WTRU may be configured to implement multi-cell operation during periods with high traffic volume and to implement single cell reception during periods of lower traffic volume. Such a scheme may be designed to limit battery consumption of WTRUs in non-DCH states with low traffic volume.

A primary cell or a primary serving cell may be the cell in which the WTRU is camped on or connected to in the non-DCH states. The primary cell may be a cell that contains a full set of information in order for the WTRU to operate in single cell configuration. The WTRU may access a primary cell prior to accessing a secondary cell. For example, the primary cell may broadcast information related to MAT operation, neighbor cell lists (NCL), other system information, and/or the like. A primary cell may provide a full set of physical channels to the WTRU. Uplink feedback, such as hybrid automatic repeat request (HARQ) ACK/NACK information may be sent via the primary cell or via an uplink cell that is coupled with the primary downlink serving cell. In an example, uplink transmissions may be sent via the primary cell. A secondary cell may be a cell over which the WTRU may receive the HS-DSCH data and/or the Common Pilot Indicator Channel (CPICH). For example, the WTRU may receive a High Speed Shared Control Channel (HS-SCCH) and/or a High Speed Downlink Physical Shared Channel (HS-DPSCH) via a secondary cell. In an example, UL transmissions and access may be performed by the WTRU over the primary serving cell, rather than the secondary cell.

It may be appreciated that although embodiments may be described in terms of downlink reception, they may be equally applicable to UL operation. The operations described herein may be performed by WTRUs supporting multi-cell operation and/or WTRUs supporting multi-cell operation in non-DCH states.

A WTRU in a non-DCH state may be configured to support multi-cell operation and to acquire configuration information for the support of multi-cell operation. As may be appreciated, the techniques described herein for supporting multi-cell operation in non-DCH states may be performed individually or in any combination. In an example, the configuration of the secondary cells may be provided or acquired by the WTRU from the System Information (SI) of a primary serving cell. For example, the primary cell may broadcast sufficient information regarding a secondary cell that allows the WTRU to connect to and/or camp on the secondary cell. Configuration information of secondary cell may be broadcasted by and received over the primary cell using System Information Blocks (SIBS) of the primary cell. One or more SIBS broadcasted by the primary cell may include identification information of one or more secondary cells. For example, the primary cell may broadcast a list of secondary cells that may be utilized by WTRUs supporting multi-cell operation in a non-DCH state.

A WTRU may be configured to receive the SI broadcast of a primary serving cell. The SI of the primary cell may include a capability bit indicating whether multi-cell operation is supported. The capability bit may be include in a SIB. In an example, a capability bit and/or a plurality of capability bits may indicate whether multi-cell operation is supported in an adjacent frequency or on a different band. The capability bit and/or the plurality of capability bits indicating whether multi-cell operation is supported in an adjacent frequency or on a different band may be broadcast by the Node B of the primary cell. In an example, the capability bit and/or a separate Information Element (IE) (e.g., a “non-DCH multi cell reception IE”) may indicate which adjacent frequency and/or which cell may be used in conjunction with the primary cell for multi-cell reception. For example, the capability bit and/or non-DCH multi-cell reception IE may indicate whether a higher and/or lower adjacent frequency may be used as a secondary cell. The system information may also provide the cell identity and/or the scrambling code that may be used by the WTRU for secondary cell reception. The capability bit and/or non-DCH multi-cell reception IE may indicate which higher and/or lower adjacent frequency (or the same frequency) may be used as a secondary cell (e.g., using an absolute radio-frequency channel number (ARFCN) information element, a physical cell ID, and/or some other identifying information). The capability bit and/or non-DCH multi-cell reception IE may indicate which frequencies or frequency bands may be used as a secondary cell. The capability bit and/or non-DCH multi-cell reception IE may indicate which cells may be configured as secondary cells by taking one of a finite set of values. Each possible value may represent a different frequency band or cell that may be used as a secondary cell. For example, a first value may indicate that a frequency band lower than the frequency band of the primary cell may be used as a secondary cell. A second value may indicate that a frequency band higher than the frequency band of the primary cell may be used as a secondary cell. A third value may indicate that a frequency band of the same frequency as the frequency band of the primary cell may be used as a secondary cell. In an example, a bitmap may be used to represent frequencies which the WTRU may use as secondary carrier frequencies. For example, each bit in the bitmap may indicate whether the associated frequency may be configured as a secondary cell for the current primary cell.

An information element, such as the non-DCH multi-cell reception IE, may explicitly indicate which frequencies may be utilized for multi-cell operation. In an example, an information element, such as the non-DCH reception IE, may indicate the maximum number of cells supported for multi-cell operation by the primary cell. For example, the Node B may broadcast N frequencies, but may be configured to support a maximum of M cells in multi-cell operation for a particular WTRU, (where N>M). The Node B may indicate the maximum number of cells supported for multi-cell operation is M using an sent to the WTRU (e.g., the non-DCH reception IF, included in either a broadcast message or a dedicated signaling message). The Node B may support dual cell operation and may broadcast information for two adjacent cells. If a WTRU that is capable of supporting three or more cells simultaneously accesses such a Node B, the WTRU may determine that it will support dual cell operation while connected to the cell served by the Node B.

One or more information elements may be defined in order to enable reception of data from one or more cells. For example, an IE, such as the non-DCH multi-cell reception IE, may be broadcast by a primary cell and may include the CPICH information of one or more secondary cells for the associated frequency. In an example, an IE, such as the non-DCH multi-cell reception IE, may include the scrambling code of the secondary cell for the associated frequency.

In an example, a WTRU may be configured to receive a secondary cell configuration by means of dedicated signaling. For example, when a WTRU connects to a cell, the WTRU may be unaware whether multi-cell operation is supported or configurable. The network may send a dedicated signaling message, such as a Radio Resource Control (RRC) message, in order to configure the WTRU with the secondary cell information for a non-DCH state. For example, the network may send one or more of a CELL UPDATE Confirm message, an RRC reconfiguration message, and/or an RRC connection setup message to the WTRU m order to configure the WTRU with secondary cell information. The CELL UPDATE Confirm message, the RRC reconfiguration message, and/or the RRC connection setup message may include an IE for multi-cell support (e.g., the non-DCH multi-cell reception IE).

In an example, a WTRU may determine secondary cell configuration information based on receiving an SI broadcast from a potential secondary cell. For example, the system information broadcast by a potential secondary cell may include one or more SIBs that include sufficient information to allow the WTRU to add the potential secondary cell as a secondary cell. The secondary cell information included in the SI may comprise one or more IEs that include the secondary cell configuration information (e.g., a non-DCH multi-cell reception and/or a “secondary cell IE”). For example, cells that support multi-cell operation in non-DCH states may broadcast a secondary cell IE in addition to the current HS-DSCH system information IE. In an example, the WTRU may acquire the HS-DSCH common system information IE from the secondary cell. The HS-DSCH system information IE broadcast by a potential secondary cell may be used by WTRUs connected and/or semi-connected (e.g., in a non-DCH state) to the broadcasting cell in order utilize the potential secondary cell as a primary serving cell (or single serving cell if the WTRU does not support multi-cell reception) or as a secondary cell. A WTRU attempting to utilize the potential secondary cell as a secondary cell in a non-DCH state may read the HS-DSCH system information IE broadcast by the potential secondary cell in order to use a subset of and/or a full set of the information included in the HS-DSCH system information IE to facilitate secondary cell reception over the potential secondary cell. The potential secondary cell may broadcast additional information, for example to explicitly indicate the capability of multi-cell support over the potential secondary cell. For example, the additional information may indicate whether the potential secondary cell is configured to be used as a secondary cell. In an example, the secondary cell may indicate the cells with which it can work as a secondary cell. If the list includes the current serving or primary cell on which the WTRU is currently camped, then the WTRU may determine that multi-cell operation with the corresponding secondary and primary cells is possible.

A WTRU may determine to acquire the system information of a potential secondary cell, for example based on various criteria (or any combination thereof). For example, a WTRU may determine to acquire the system information of a potential secondary cell based on detecting or receiving an indication in a primary serving cell that the Node B associated with the primary serving cell supports multi-cell (e.g., or dual-cell) operation. In an example, system information broadcast by a primary cell may include one or more SIBs that may indicate the identity of potential secondary cells (e.g., a list of secondary cells). The WTRU may determine to acquire system information based on the lists received in the system information of the primary cell. The identification of potential secondary cells may be explicitly signaled to the WTRU. In an example, the system information of the primary cell may include an indication of the scrambling code used by the secondary cell and/or CPICH info of the secondary cell. The WTRU may determine whether to attempt to acquire the system information of a potential secondary cell based on the received indication of the scrambling code used by the secondary cell and/or CPICH info of the secondary cell. In an example, dedicated signaling (e.g., of a CELL UPDATE Confirm message, an RRC reconfiguration message, and/or RRC connection setup message) may be sent to the WTRU in order to indicate that the WTRU may acquire the secondary cell information via system information of a potential secondary cell. The frequency of the potential secondary cell, the primary synchronization code (PSC) of the potential secondary cell, and/or CPICH info of the potential secondary cell may be indicated in the dedicated and or common (e.g., SIB) signaling message.

In an example, a Node B may be configured to support and maintain N secondary cells (or N frequency bands). However, a WTRU may be configured to support multi-cell operation up to a total of M cells, where M is less than or equal to N. Whether multi-cell operation is supported may be determined by the network, for example based on the capabilities of the WTRU. In an example, the number of secondary cells allowed for non-DCH reception may be predefined by the network. In an example, the network may allow dual cell reception in non-DCH states (e.g., CELL_FACH), but may prohibit the WTRU from connecting to more than two cells simultaneously. In another example, the network may allow WTRUs a non-DCH state to connect to more than two cells simultaneously. The network may determine the maximum number of cells that the WTRU is allowed to connect to, and indicate the maximum number to the WTRU. The WTRU may determine the identity of cells to configure and connect to up to the maximum number. In an example, the WTRU may determine the number of cells it may configure for multi-cell reception based on one or more criteria. For example, the WTRU may determine the number of cells it may configure for multi-cell reception to be the maximum number of cells supported by the WTRU for multi-cell reception. The WTRU may determine the number of cells it may configure for multi-cell reception to be the maximum number of cells broadcast and supported by the Node B. The WTRU may determine the number of cells it may configure for multi-cell reception to be the maximum number of cells that support multi-cell transmission to WTRUs in a non-DCH state. In an example, the WTRU may determine the number of cells it may configure for multi-cell reception to be the minimum of the maximum number of cells supported by the WTRU for multi-cell reception, the maximum number of cells broadcast and supported by the Node B, and the maximum number of cells that support multi-cell transmission to WTRUs in a non-DCH state. In an example, the WTRU may determine the number of cells to configure of multi-cell, non-DCH reception to be a value explicitly signaled to the WTRU via dedicated signaling, for example via RRC or Medium Access Control (MAC) signaling. The network may take into account the WTRUs capabilities when determining the explicit value to be sent via dedicated signaling.

In an example, the WTRU may determine the number of cells it may configure for multi-cell reception in a non-DCH state based on the capabilities of the WTRU. In an example, the number of cells configured by the WTRU of multi-cell reception in a non-DCH state may be less than the number of cells that the WTRU may configure for multi-cell reception in the CELL_DCH state. For example, the WTRU my be capable of or may be configured to support reception over N cells in a CELL_DCH state (e.g., 8 cells), and may be capable of or may be configured to support reception over M cells in a non-DCH state (e.g., 2 cells), where M<N. In an example, the WTRU may determine the number of cells it may configure for multi-cell reception in a non-DCH state based on the frequencies and/or frequency bands it can supported and based on the frequency and/or frequency bands in which multi cell operation is available as broadcasted or provided by the network. Additionally, the band combination supported by the WTRU may be taken into account in determining the number of cells. For example, if the WTRU supports adjacent dual cell operation but does not support dual cell reception among multiple bands, and the network indicates that the potential secondary serving cells that are available are in a band that is different than the band of the serving cell, then the WTRU may determine that it cannot perform dual cell operation in the current serving cell. If the WTRU supports dual band dual cell operation, and the WTRU supports the band combination formed by the serving cell band and the indicated secondary cell band, then the WTRU may determine that it can support dual cell operation using the combination.

In a given area, there may be a number of potential secondary cells that are configured for multi-cell operation for WTRUs in a non-DCH state. Of the number of potential secondary cells that are configured for multi-cell operation for WTRUs in a non-DCH state, a WTRU may be allowed to access or connect to a subset of the potential secondary cells. The WTRU may determine which cells it is allowed to use as secondary cells based on a list of potential secondary cells broadcast by a primary cell and/or based on the identity of previously acquired secondary cells. The WTRU may determine which potential secondary cells it is allowed to connect to based on the band/frequency combination of the potential secondary cell and/or the capabilities of the WTRU. For example, a primary cell may indicate a potential secondary cell that operates in a frequency/band that is not supported by the WTRU. The WTRU may determine that it is not allowed to connect to this potential secondary cell for multi-cell operation in a non-DCH state. Hence, a WTRU may determine the allowed secondary cells based on the list of potential secondary cells, the frequency/band information of the potential secondary cells, and the capabilities of the WTRU (e.g. the number cells the WTRU can support for multi-cell operation). A potential secondary cell that the WTRU is allowed to access may be referred to a secondary cell candidate.

In an example, a secondary cell may be considered a candidate cell if the channel quality measurement are within a configured or predetermined threshold. For example, a secondary cell may be considered a candidate cell if the channel quality measurement are) within a configured or predetermined threshold for a configured or predetermined period of time. Channel quality measurements may include pathloss measurements, Ec/No measurements, reference signal received quality (RSRQ) measurements, received signal strength indication (RSSI) measurements, and/or channel quality indicator (CQI) measurements. In an example, a secondary cell may be considered a candidate if the channel quality measurement is within a configured or defined threshold value from the serving or primary cell. For example, a secondary cell may be considered a candidate if the channel quality measurement is within a configured or defined threshold value from the serving or primary cell for a defined and/or predetermined period of time.

The WTRU may determine to configure a secondary cell candidate as a secondary cell while in a non-DCH state based on one or more predetermined rules. For example, the WTRU may configure a secondary cell candidate as a secondary cell no other candidate cells are available. In an example, the WTRU may select the higher frequency adjacent cell and/or the lower frequency adjacent cell as a cell to use as a secondary cell (e.g., if the higher frequency adjacent cell and/or the lower frequency adjacent cell are secondary cell candidates). In an example, the WTRU may randomly choose one of the secondary cell candidates as a secondary cell for multi-cell reception in a non-DCH state. In an example, the WTRU my prioritize a cell in the same frequency band as the serving cell when selecting a secondary cell for multi-cell reception in anon-DCH state. In an example, the WTRU may prioritize a frequency in different band than that of the primary cell when selecting a secondary cell for multi-cell reception in a non-DCH state. Thus, the WTRU may be configured to select a secondary cell operating at a frequency that is located in a different frequency band that the frequency band of the primary serving cell for the WTRU.

The WTRU may determine to select the secondary cell with the highest channel quality measure from the allowed secondary cells. In an example, the WTRU may determine to select cells in a certain prioritized frequency. In an example, an allowed secondary cell belonging to the next highest priority frequency according to an inter-frequency cell reselection priority setting may be selected. The network may explicitly signal the secondary frequency to be used by the WTRU. The network may send to the WTRU an index that identifies the frequencies, frequency band, and/or identity of the secondary cells that the WTRU should use. The network may explicitly indicate the frequency values and/or CPICH info that the WTRU should use for secondary cells. In an example, the WTRU may chose the first cell for which it can successfully decode the system information as a secondary cell.

If the WTRU acquires secondary cell configuration information from the secondary cell SIBs (e.g., on a different cell in the same frequency or a different frequency as the primary serving cell), the WTRU may determine which cell(s) to acquire based a predetermined priority, the signal strength of the secondary cells, the frequency or frequency band of the secondary cells, and/or based on an explicit indication signaled by the network. If the SIBs of the primary cell broadcast a capability bit but do not provide identifying information regard a secondary cells, the WTRU may determine to read the SIBs of adjacent cells (e.g., a higher frequency adjacent cell and a lower frequency adjacent cell) and configure one as a secondary cell based on predetermined priority (e.g., connect to the higher frequency first or connect to the lower frequency first) and/or based on the signal strength of the secondary cells.

A WTRU may transmit its capabilities multi-cell reception capabilities to the network (e.g., WTRU Capability information). For example, the WTRU may receive a capability inquiry from the network and may respond with WTRU capability information. The WTRU capability information may indicate the multi-cell reception capability of the WTRU, the non-DCH multi-cell reception capability of the WTRU, the physical layer capabilities of the WTRU, and/or the multiple input multiple output (MIMO) capabilities of the WTRU

The WTRU may indicate to the network the number of cells the WTRU will use for multi-cell reception in non-DCH state, the selected frequencies of the selected cells, and/or the identity of the cells selected for multi-cell reception in non-DCH states. For example, the WTRU may send the network the PSC or CELL ID of a secondary cell once the WTRU has determined the frequency it will use for multi-cell mode. In an example, the WTRU may indicate to the network that it has successfully decoded the SIBs of the secondary cell. When indicating that it has successfully decoded the SIBs of a secondary cell, the WTRU may also indicate whether it will perform multi-cell operation on that cell. For example, the WTRU may inform the network by including this information in the CELL UPDATE message. In an example, the WTRU may include information regarding its dual cell/multi-cell selections in an RRC message to be sent to the network. In an example, the WTRU may include information regarding its dual cell/multi-cell selections in a MAC Packet Data. Unit (PDU), for example to ensure that the Node B receives the information. The WTRU may select one of a set of preambles upon initiation of uplink transmission. The set of preambles may be reserved and may be provided over system information of the primary or secondary cell.

The WTRU may determine when secondary cell reception in non-CELL_DCH states should be initiated. For example, methods to determine when to configure the secondary cell(s) and when to activate/deactivate the secondary cells may be configured in the WTRU. As may be appreciated, the techniques for determining when cell reception in non-CELL_DCH states should be initiated may be used individually or in combination.

The WTRU may initiate secondary cell reception upon connection to a cell or upon transition to a non-DCH state. For example, secondary cell reception may be initiated when the WTRU camps on a cell or reselects to a new cell. If the WTRU acquires the secondary cell information, as is described above, it may immediately configure the secondary serving cell and start receiving over the secondary cell(s). The WTRU may be capable of receiving common or dedicated data over more than one cell. For example, the Common Control Channel (CCCH), Dedicated Traffic Channel (DTCH), and/or Dedicated Control Channel (DCCH) may be received over more than one cell. For CCCH transmission the WTRU may use a common HS-DSCH Radio Network Temporary Identifier (H-RNTI) to monitor the secondary cell. In an example, a secondary common H-RNTI may be determined and selected for use in secondary cell reception. In an example, if the WTRU is in a non-DCH state and no dedicated H-RNTI is present, the WTRU may still set the variable to TRUE and initiate secondary cell reception using a common H-RNTI. The configuration of a secondary HS-DSCH cell for CCCH in non-DCH state may be linked to the state of the HS-DSCH reception for CCCH in the primary cell. For example, if HS-DSCH reception for CCCH in the primary cell is enabled, then HS-DSCH reception for CCCH in the secondary cell may also be enabled. Similarly, if HS-DSCH reception for CCCH in the primary cell is disabled, then HS-DSCH reception for CCCH in the secondary cell may also be disabled. DTCH/DCCH reception may be allowed in the secondary cell once the WTRU is configured with a dedicated H-RNTI.

The WTRU may determine that it is allowed to perform secondary cell reception and acquire the secondary cell information IE from the SIBs (e.g., a non-DCH multi-cell reception IE). However, the WTRU may delay the initiation of secondary cell reception and/or configuration. The WTRU may store the information and start secondary or multi-cell operation when one or a combination of criteria is met. For example, the WTRU may delay secondary cell reception and/or configuration until the WTRU is receiving DCCH and/or DTCH traffic and/or until the WTRU is configured with dedicated WTRU IDs (e.g., C-RNTI, H-RNTI, E-RNTI, etc.). In another example the delay may be until the WTRU has a secondary H-RNTI (i.e., H-RNTI for the secondary cell) configuration. The WTRU may use the same H-RNTI for reception over two cells.

In another example, the WTRU may delay secondary cell reception and/or configuration until the WTRU receives a CELL UPDATE confirm message. The CELL_UPDATE confirm message may provide information to the WTRU indicating approval of the selection performed by the WTRU and/or indicating which cells the WTRU should configure for secondary cell selection. Another example may be delaying the secondary cell reception and/or configuration until the WTRU transitions to a non-DCH state via a dedicated RRC signaling. In an example, the dedicated RRC signaling may include a dedicated H-RNTI for the secondary. In an example, the WTRU may delay secondary cell reception until the WTRU is in a CELL_FACH state or transitions to a CELL_FACH state. For example, the transition may be from CELL_PCH based on the WTRU detecting a dedicated H-RNTI in the HS-SCCH for the primary cell. In this example, when in CELL_PCH the WTRU may monitor the primary cell, and once it transitions to CELL_FACH it may start multi-cell operation.

In another example, the WTRU may delay secondary cell reception and/or configuration until the HS_DSCH reception in CELL_FACH state of the primary cell is configured and allowed. For example, the WTRU may delay secondary cell reception and/or configuration until the HS_DSCH_RECEPTION_CELL_FACH_STATE is set to TRUE. In an example, the WTRU may delay secondary cell reception and/or configuration until an explicit indication that indicates that the WTRU may configure multi-cell operation is received by the WTRU via an RRC message. For example, the WTRU may configure multi-cell operation according to a dedicated secondary cell information configuration include in the RRC message or according to a configuration previously received/stored in the w WTRU. The configuration previously received/stored in the WTRU may have been received over in system information or over the dedicated signaling.

The WTRU may determine whether the criteria to perform HS-DSCH reception in a secondary cell is met once the configuration information of the secondary cell is received or acquired from the system information (e.g., from the primary and/or secondary cell). If the WTRU determines that the criteria for performing HS-DSCH reception in a secondary cell is not met, the WTRU may delay configuring the secondary cell, but keep the secondary cell information stored for later multi-cell reception. In an example, the WTRU may be triggered to make a determination regarding whether the criteria for multi-cell reception from a secondary cell is satisfied. For example, the WTRU performing a state transition to a non-DCH state and/or a state transition within a non-DCH state may be an example trigger that causes the WTRU to make a determination regarding whether the criteria for multi-cell reception from a secondary cell is satisfied. In an example, the WTRU receiving a CELL UPDATE confirm message may be an example trigger that causes the WTRU to make a determination regarding whether the criteria for multi-cell reception from a secondary cell is satisfied. For example, the WTRU may be triggered to determine whether the criteria for multi-cell reception from a secondary cell is satisfied based on receiving a. CELL UPDATE confirm message following a cell reselection, radio link failure (RLF), and/or the occurrence of a radio link control (RLC) unrecoverable. Another example of a trigger that may cause the WTRU to make a determination regarding whether the criteria, for multi-cell reception from a secondary cell is satisfied may be when a WTRU transitions to CELL_FACH state and/or a CELL_PCH state.

The WTRU may delete the secondary cell reception configuration information and/or release secondary cell reception based on detecting one or more secondary cell release triggers. Examples of secondary cell release triggers that cause the WTRU to delete secondary cell configuration information and/or release secondary cells in current operation may include the WTRU determining that a cell reselection has been or is being performed, the secondary dedicated H-RNTI being deleted, Radio link failure detection, the WTRU moving to CELL_FACH and/or a combination thereof. Other examples of secondary cell release triggers that cause the WTRU to delete secondary cell configuration information and/or release secondary cells in current operation may include the WTRU deleting the dedicated H-RNTI of the primary cell, the WTRU going out-of-service, and/or the WTRU moving to idle mode. For example, the WTRU may delete secondary cell configuration information and/or may release secondary cells in current operation when CCCH Reception over two cells is not supported. Examples of secondary cell release triggers that cause the WTRU to delete secondary cell configuration information and/or release secondary cells in current operation may also include the WTRU transitioning to the URA_PCH state, the WTRU transitioning to the CELL_PCH state, and/or the WTRU transitioning to the CELL_PCH state during a period in which the WTRU does not have dedicate H-RNTI configured. In another example, the WTRU may be explicitly configured to start multi-cell operation via dedicated signaling.

The WTRU may perform fast activation/deactivation of secondary cells while in non-DCH states. An activated secondary cell may be a cell for which the WTRU has configuration information and is actively monitoring for downlink transmissions. A deactivated secondary cell may be a cell which the WFRU has configuration information but does not actively monitor for downlink transmission. Once configured with dual cell or multi-cell operation, the WTRU may determine the activation/deactivation status based on one or a combination of the following methods. In one example, the WTRU may determine that upon receiving the configuration information for a secondary cell, the secondary cell may be active at all times following its configuration. Since it may be desirable to minimize battery usage, leaving secondary cells active at all times following their configuration may be non-ideal from a power consumption standpoint. In an example, the WTRU may determine that the initial status of the secondary cells configured for operation in a non-DCH state is a deactivated status. Hence, a WTRU would first receive configuration information for a secondary cell, but the cell would be deactivated until the WTRU received activation information for the secondary cell. In an example, the initial activation status of a secondary cell may be provided to the WTRU using RRC signaling, for example via a Cell Update Confirm message or System Information.

A WTRU may be configured to dynamically determine the initial activation status of a secondary cell. For example, the WTRU may determine that a secondary cell is initially deactivated based on the secondary cell being configured and/or multi-cell operation being triggered based on a cell update procedure that occurred due to a cell reselection, radio link failure, and/or an RLC unrecoverable error. In an example, the WTRU may determine that a secondary cell is initially deactivated based on the secondary cell being configured and/or multi-cell operation being triggered in a CELL UPDATE CONFIRM message that is received by the WTRU. In an example, the WTRU may determine that a secondary cell is initially deactivated based on the secondary cell being configured and/or multi-cell operation being triggered based on the WTRU performing state transition within a non-DCH state and/or to/from anon-DCH state.

The WTRU may perform activation of secondary cells in non-CELL_DCH states, for example if the secondary cell is initially deactivated and/or after the secondary cell has been deactivated. For example, the WTRU may perform activation of one or more secondary cells in response to the WTRU receiving dedicated HS-SCCH or HS-PDSCH data in the primary cell. For example, any dedicated downlink activity received in the primary cell by the WTRU may trigger the WTRU to start secondary cell reception (e.g., activate the secondary cell). In an example, if the amount of downlink activity exceeds a predetermined threshold, then the WTRU may activate one or more secondary cells. For example, if the amount of data received by the WTRU over a certain time period (e.g., a predetermined number of Transmission Time Intervals (TTIs)) exceeds a predetermined threshold, the WTRU may activate one or more secondary cells. In an example, if the number of bits received in the downlink for a certain period of time exceeds a threshold, the WTRU may activate one or more secondary cell. The WTRU tray perform activation of secondary cells when the WTRU transitions from DRX to continuously receiving HS-DSCH (e.g., when the T321 timer is running and the WTRU is not performing DRX). The WTRU may perform activation of secondary cells when a common E-DCH resource is allocated to the WTRU.

The WTRU may perform activation of secondary cells in non-CELL_DCH states based on a frequency of and/or an amount of data transmitted in the uplink. For example, the WTRU may be configured to activate one or more secondary cells based on the initiation of a ramp-up procedure and/or upon successful reception of an E-DCH resource with extended acquisition indicator (E-AI). In an example, the WTRU may be configured to activate one or more secondary cells based on successful completion of a contention resolution procedure (e.g., for the RACH and/or E-DCH).

The WTRU may perform activation of secondary cells in non-DCH states upon receiving an activation order. The activation order may indicate the number of secondary cells to be activated. The activation order may indicate the identity of the secondary cells to be activated (e.g., using a physical cell identification or other identifying indicia). For example, the WTRU may receive an activation order from a Node B via physical layer (e.g., Layer 1 (L1)) signaling. For example, an HS-SCCH order may be transmitted from the primary cell or an active secondary cell to indicate to the WTRU that it may being reception on one or more secondary carriers. In another example, the activation order may be received via Layer 2 (L2) signaling. For example, a MAC control element (e.g., a new field in a MAC header) may be included to activate reception on one or more secondary carriers. In another example, the activation order may be received via RRC signaling.

The WTRU may be configured to activate one or more secondary cells based on the fast HS-DPCCH setup may be performed. For example, if the network sends a request to initiate HS-DPCCH feedback and/or if WTRU initiates HS-DPCCH feedback, the WTRU may be triggered to activate one or more secondary cells. In an example, the WTRU activate one or more secondary cells if the network sends a request to initiate HS-DPCCH feedback and/or if WTRU initiates HS-DPCCH feedback even if there is no UL data to be included as part of the feedback transmission. The RAN may configure the fast HS_DPCCH channel prior to activating the secondary cell so that the WTRU may acknowledge the activation of a secondary cell.

In an example, the WTRU may be configured to activate one or more secondary cells if a HS-DPCCH is setup and HS-SCCH or HS-PDSCH data dedicated to the WTRU is received on the primary cell, the amount of DL activity over a given time exceeds a threshold, the WTRU transmits uplink data, and/or a combination thereof HS-SCCH or HS-PDSCH data dedicated to this UE is received on the primary cell a common E-DCH resource is setup. For example, the RAN may configure the common E-DCH channel prior to activating the secondary cell so that the WTRU may acknowledge the activation of a secondary cell. In an example, the WTRU may perform activation of secondary cells in a non-CELL_DCH state upon the WTRU transitioning to CELL_FACH from CELL_PCH, for example upon detection of a dedicated H-RNTI on the HS-SCCH.

The WTRU may deactivate one or more secondary cells based on one or more of the following criteria. For example the WTRU may deactivate one or more secondary cells based on downlink activity. For example, if no downlink activity has taken place for a given period of time on the secondary cell and/or on any of the active cells (e.g., primary and/or secondary cells), the WTRU may deactivate the secondary cell. In an example, the WTRU may be configured to deactivate one or more secondary cells based on the WTRU performing DRX in CELL_FACH. For example, the WTRU may deactivate one or more secondary cells based on when the WTRU beginning operation in inactive/sleep time of a DRX cycle. The WTRU may deactivate secondary cell reception upon expiry of the T321 timer, which may trigger the WTRU to transition to DRX operation.

The WTRU may deactivate the secondary cell based on the WTRU moving to CELL_PCH, for example when transitioning from CELL_FACH to CELL_PCH. In an example, the WTRU may deactivate one or more secondary cells based on common E-DCH resources being released. Another example of a trigger that may cause the WTRU to deactivate one or more secondary cells may be dedicated HS-DPCCH feedback resources being released. The WTRU may deactivate one or more secondary cells based on reception of an explicit deactivation indication from the network (e.g., via physical layer, mac layer, and/or RRC layer signaling).

A secondary cell deactivation order may be received by the WTRU from the network via one or more signaling methods. The deactivation order may indicate the number of secondary cells to be deactivated. The deactivation order may indicate the identity of the secondary cells to be deactivated (e.g., using a physical cell identification or other identifying indicia). For example, the network may send a secondary cell deactivation order to the WTRU using L1 signaling. For example, an HS-SCCH order may be transmitted from the primary cell (or from a secondary cell) to indicate to the WTRU to stop the reception on one or more secondary carriers. In another example, the secondary cell deactivation order may be sent via L2 signaling. For example, a MAC control element (e.g., new field in a MAC header) may be included to deactivate reception on one or more secondary carriers. In another example, the deactivation order may be sent via RRC signaling.

If the WTRU is in CELL_PCH and has two or more dedicated H-RNTIs, it may monitor more than one cell over the five subframes, or the WTRU may monitor a single cell. Upon detection of scheduling when the WTRU transitions to CELL_FACH, the WTRU may begin operating with multi-cell operation.

The WTRU may provide feedback on the quality of secondary cells in non-DCH states. The feedback may be used by the RAN to determine when to start or stop transmission to a WTRU in non-DCH state on a secondary cell. The various options described herein may be used individually or in combination.

The WTRU may determine to begin transmission of fast HS-DSCH uplink feedback based on the initiation of reception on a secondary downlink carrier. For example, the WTRU may be assigned a set of resources to enable transmission of uplink of HS-DPCCH. The resources may be from a pool of common resources or as a set of dedicated radio resource. In an example, the set of resources may also contain E-DCH resources to allow the WTRU to transfer uplink data.

The WTRU may be configured with information to perform HS-DSCH reception on more than one cell. For example, the WTRU may receive HS-DSCH over a single cell at a time and/or may be capable of dynamically switching the cell over which HS-DSCH is received. For a given instant in time, the WTRU may determine from which cell to receive HS-DSCH based on fast activation orders. For example, the default configuration for a WTRU default when beginning reception of HS-SCCH may be to receive the HS-SCCH on the serving or cell on which the WTRU is connected/camped on. The network may signal to the WTRU to stop reception in one cell and begin reception on a different cell. The indication to switch the cell used for HS-SCCH reception may be includes in HS-SCCH orders sent over the cell the WTRU is currently using for HS-SCCH reception. The HS-SCCH order may indicate the cell over which the WTRU is to begin receiving HS-SCCH and/or HS-DPSCH. The time at which the WTRU is to transition reception for HS-SCCH to the new cell (e.g., from a primary cell to a secondary cell, from a secondary cell to a different secondary cell, and/or from a secondary cell to a primary cell) may be a configured by the network, may be a predefined time, and/or may be based on a second indication sent from the network. The indication to transition HS-SCCH reception to a new cell may also indicate the amount of time the WTRU is to receive the HS-SCCH via the new cell before transitioning HS-SCCH reception back to the old cell.

In an example, the WTRU may send Radio Frequency (RF) quality measurements for the secondary cell to the network through higher layer signaling. The RF quality measurements may include various performance measures and/or WTRU parameters. For example, the RF quality measurements my include the received signal level or received signal code power (RSCP) of the CPICH or another reference channel transmitted on the secondary cell. In an example, RF quality measurements may include the quality or portion of the signal that is useable (e.g. the ratio of received energy per PN chip to the total received power spectral density—Ec/Io) of the CPICH or another reference channel transmitted on the secondary cell.

The WTRU may be configured to transfer a measurement report if specified conditions are satisfied. For example, the WTRU may be triggered to send a measurement report if the measured value or quality increases above a predetermined or configured threshold. The WTRU may be triggered to send a measurement report if the measured value or quality increases above a predetermined or configured threshold for a predetermined period of time. Such measurement reports may be an indicator to the RAN to activate or start transmission on the secondary cell. In an example, if the measured value or quality decreases below a predetermined or configured threshold, the WTRU may transmit a measurement report. The WTRU may be triggered to send a measurement report if the measured value or quality decreases below a predetermined or configured threshold for a predetermined period of time. These measurement reports may be an indicator to the RAN to deactivate or stop transmission on the secondary cell if desired.

In an example, if the number of reception failures on a secondary cell exceeds a pre-determined or configured threshold (for example within a predetermined time period), the WTRU may send a measurement report. The number of reception failures may be counted in a number of ways. For example, the WTRU may monitor the block error rate (BLER) for individual downlink transmissions, the HARQ BLER, the number of HARQ failures, and/or any other measurement of downlink reception failure. These measurements or a combination thereof may be used to determine the number and/or effect of reception failures.

The WTRU may transmit the measurement report using several types of mechanisms. For example, the measurement report may be transmitted using RRC signaling. The WTRU may include the IE “Measure Results on RACH” in an RRC message. In an example, a new IE may be defined and included in any existing or new RRC message in order to transmit the measurement report. In another example, a MAC layer control element, such as a special value of the scheduling information, may be used to transmit the measurement report.

The WTRU may transfer a message indicating that it is capable from an RF standpoint to receive on a secondary carrier in favorable RF conditions. Similarly, the WTRU may send an indication that it is no longer capable of receiving on a secondary carrier (e.g., request for secondary carrier deactivation). In another example, the WTRU my trigger the start or stop of HS_DPCCH transmission in the uplink as described above according to any of the conditions described above.

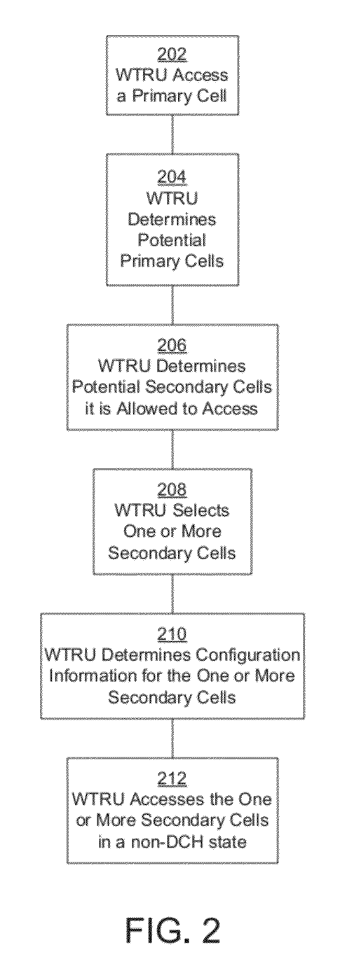

FIG. 2 is a flow chart illustrating an example method for a WTRU to establish multi-cell reception in a non-DCH state. As may be appreciated, the processing steps described with relation to FIG. 2 may be performed different arrangements or orders. Thus, FIG. 2 is not meant to imply any order of processing steps.

For example, at 202 a WTRU may access a primary cell. For example, the WTRU may be initially camped on the primary cell. The WTRU may be connected to and/or may access the primary cell while in a non-DCH state, for example the CELL_FACH state. The WTRU may acquire some or all of the system information of the primary cell in order to access the cell. At 204, the WTRU may determine potential primary cells. For example, the primary cell may broadcast a list of potential secondary cells in its system information. The WTRU may determine the potential secondary cells based on the list of potential secondary cells provided by the primary cell. The WTRU may determine the potential secondary cells based on measurements performed by the WTRU.

At 206, the WTRU may determine the number of and/or identity of potential secondary cell it is allowed to access. For example, the network may place restrictions on the number and or identity of secondary cells a particular WTRU is allowed to access in a non-DCH state. Therefore, a WTRU may broadcast a given cell as a potential secondary cell, but certain specific WTRUs may not be allowed to access the given cell due to WTRU specific restrictions.

At 208, the WTRU my select one or more potential secondary cells as a secondary cell candidate. A secondary cell candidate may be a cell that is a potential secondary cell that the WTRU is allowed to access. The WTRU may determine which potential secondary cells are secondary cell candidates based on one or more of predefined rules (e.g., predefined priority rules), access restrictions provided by a Node B/RNC (e.g., via dedicated signaling), based on its current state (e.g., there may be specific rules for a CELL_FACH state vs. a CELL_PCH state vs. a CELL_PCH state etc.), based on configuration of the WTRU (e.g., the WTRU may be limited to multi-cell reception over no more than M cells at a given instance, where M is an integer), and/or the like.

At 210, the WTRU may determine configuration information for one or more of the secondary cells. For example, the WTRU may determine configuration information for the determined secondary cell candidates. In an example, the WTRU may determine configuration for some or all of the potential secondary cells. The WTRU may determine the configuration information of a particular secondary cells by reading the system information of the particular secondary cell and/or by reading the system information of the primary cell. The WTRU may receive configuration information for a secondary cell via dedicated signaling (e.g., a dedicated message received from the primary cell). At 212 the WTRU may access the one or more secondary cells while in a non-DCH state. For example, the WTRU may begin reception of one or more channels over the secondary cell. The WTRU may receive data from the secondary cell while simultaneously accessing the primary cell.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, LIE, terminal, base station, RNC, or any host computer.

What is claimed:

1. A method for a wireless transmit/receive unit (WTRU) to establish multi-cell operation in a non-fully connected state, the method comprising:
the WTRU accessing a primary cell;
the WTRU determining at least one potential secondary cell; and
the WTRU initiating access to the at least one potential secondary cell while simultaneously accessing the primary cell in a non-fully connected state, wherein the non-fully connected state corresponds to the WTRU accessing the primary cell without dedicated radio resources being allocated to the WTRU.

2. The method of claim 1, wherein the WTRU determines the at least one potential secondary cell based on a list potential secondary cells broadcast by the primary cell.

3. The method of claim 2, wherein the list of potential secondary cells is included in an information element of a system information block (SIB) of the primary cell.

4. The method of claim 2, further comprising the WTRU determining which cells included on the list of potential secondary cells that it is allowed to access based on WTRU specific access restriction information received from a Node B.

5. The method of claim 1, further comprising the WTRU receiving an indication from the primary cell, the indication indicating whether the primary cell supports multi-cell reception for WTRUs in the non-fully connected state.

6. The method of claim 1, further comprising the WTRU receiving configuration information for the at least one potential secondary cell from the primary cell.

7. The method of claim 6, wherein the configuration information includes at least one of an indication of a scrambling code used by the at least one potential secondary cell or common pilot indicator channel (CPICH) information for the at least one potential secondary cell.

8. The method of claim 1, wherein the non-fully connected state is a CELL_FACH state.

9. A wireless transmit/receive unit (WTRU) comprising a processor coupled to a transceiver, the processor configured to:
access a primary cell;
determine configuration information for at least one potential secondary cell; and
activate the at least one potential secondary cell while simultaneously accessing the primary cell in a non-fully connected state, wherein the non-fully connected state corresponds to the WTRU accessing the primary cell without dedicated radio resources being allocated to the WTRU.

10. The WTRU of claim 9, wherein the processor is configured to at activate the at least one potential secondary cell in response to a transition to a CELL_FACH state.

11. The WTRU of claim 9, wherein the processor is configured to at activate the at least one potential secondary cell in response to receiving downlink transmissions from the primary cell.

12. The WTRU of claim 9, wherein the processor is configured to at activate the at least one potential secondary cell based on the WTRU operating in a CELL_FACH state and High Speed Data-Shared Channel (HS-DSCH) reception being configured in the primary cell.

13. The WTRU of claim 9, wherein the processor is further configured to delete the configuration information for the at least on potential secondary cell based on the WTRU performing a cell reselection, the WTRU transitioning from a CELL_FACH state, or the WTRU detecting radio link failure (RLF).

14. The WTRU of claim 9, wherein the processor is configured to activate the at least one potential secondary cell in response to downlink transmissions over a predetermined time period exceeding a predetermined threshold.

15. The WTRU of claim 9, wherein the processor is configured to activate the at least one potential secondary cell in response to a dedicated message from a Node B serving the primary cell, the dedicated message being one of a physical layer message, a medium access control (MAC) control element (CE) or a radio resource control (RRC) message.

16. The WTRU of claim 9, wherein the transceiver is configured to send feedback regarding the at least one potential secondary cell to the primary cell.

17. The WTRU of claim 9, wherein the transceiver is configured to send High Speed-Downlink Control Channel (HS-DCCH) uplink feedback after the processor activates the at least one potential secondary cell.

18. A Node B comprising:
a processor configured to:
provide access to a core network for a wireless transmit/receive unit (WTRU) via at east two cells, wherein the at least two cells comprise a primary cell and a secondary cell, and
determine configuration information for the secondary cell, wherein the configuration information is configured to allow the WTRU to access the secondary cell while in a non-fully connected state and the non-fully connected state corresponds to the WTRU accessing the primary cell without dedicated radio resources being allocated to the WTRU; and
a transceiver configured to broadcast the configuration information for the secondary cell over the primary cell.

19. The Node B of claim 18, wherein the processor is further configured to send a message to the WTRU, the message requesting that the WTRU begin reception of the secondary cell.

20. The Node B of claim 18, herein the transceiver is further configured to receive a measurement report for the secondary cell from the WTRU via the primary cell.
